(19) United States
(12) Patent Application Publication
(10) Pub. No.: US 2016/0098946 A1
(43) Pub. Date: Apr. 7, 2016

(54) Polygonal Unibody Pole Sign

(71) Applicants: Andrew Wilfred LeMay, Avondale, AZ (US); Edouard Charles LeMay, Avondale, AZ (US)

(72) Inventors: Andrew Wilfred LeMay, Avondale, AZ (US); Edouard Charles LeMay, Avondale, AZ (US)

(21) Appl. No.: 14/850,898

(22) Filed: Sep. 10, 2015

Related U.S. Application Data
(60) Provisional application No. 62/049,653, filed on Sep. 12, 2014.

(51) Int. Cl. G09F 15/00; G09F 7/18; G09F 23/00

(52) U.S. Cl. CPC G09F 15/0037; G09F 23/00; G09F 7/18; G09F 2007/1856

(57) ABSTRACT

A Polygonal Unibody Pole Sign is a single piece of cardboard, or other flexible, semi-rigid material, designed to enclose a pole, post, or column, that can remain elevated without adhesives, or external support while providing surfaces for advertising, display, or decoration. Installation does not require the Polygonal Unibody Pole Sign to be placed over the top of the pole, column or beam. Instead, the invention is wrapped around the support and kept enclosed by inserting tabs at one vertical end into slots in the other. Flaps with circular or other shaped aperture the same diameter of the support in place along the horizontal ends of each display panel are then folded inward to enclose the support and hold the invention at height. The final installed Polygonal Unibody Pole Sign then presents display surfaces visible from multiple directions, providing 360 degree visibility in the preferred enclosed embodiment.

### PRODUCT HISTORY

U.S. Pat. No. 5,606,815 to Feldwhere on Mar. 4, 1997, details a pole-mountable, polygonal-section sign support. When assembled, the structure provides a multiple paneled, elevated sign viewable from multiple directions. While this invention does disclose a self-supporting, elevated, multiple-paneled sign, it does so by using multiple individual pieces attached by multiple tabs and slots to provide stability, requiring increased production costs and complexity.

U.S. provisional patent application No. 61/553,251, filed Oct. 31, 2014, details an upright object surround. When assembled, the structure provides a multiple paneled, elevated sign viewable from multiple directions. While this invention does disclose a single-piece, multiple-paneled elevated sign, it does so by requiring external support, such as cables, existing pole surfaces or other methods, to maintain elevation. Therefore, there is a need for a device that can provide a single-piece, self-supporting, elevated polygon sign, where all scoring and cutting is applied to a single blank, reducing production costs and complexity of installation. The present invention accomplishes these objectives.

### DETAILED DESCRIPTION OF THE PREFERRED EMBODIMENT

A Polygonal Unibody Pole Sign 17 contains multiple, full overlap flaps 2a 3a 4a 5a 2c 3c 4c 5c along the top and bottom (along the horizontal sides), a tab or tabs 1a 2a along one vertical side, with a corresponding slot or slots 6a 6b along the opposite vertical side, and multiple panels 2b 3b 4b 5b (panel numbers depend upon the direction of the intended advertisement and/or function: one direction=one panel, two directions=two side by side panels, three direction=triangular box, four directions=cube or rectangular box, and so forth). Each flap 2a 3a 4a 5a 2c 3c 4c 5c contains a central circular or other shaped aperture 11 (mirroring the pole 18 for which the flap will surround), a single cut 13 on the far side of the aperture 11 away from the panel 2b 3b 4b 5b for which the flap 2a 3a 4a 5a 2c 3c 4c 5c is attached; thus dividing each flap 2a 3a 4a 5a 2c 3c 4c 5c to allow the pole 18 to enter the aperture 11, and two folds 12a 12b on opposite sides, parallel to the cut 13 equal to the diameter of the attaching pole 18 allowing it to pass between the folds 12a 12b when opened. Each tab 1a 1b width is equal the width of that tabs 1a 1b corresponding slot 6a 6b, but is positioned lower by the height of the notch 1c in that tab 1a 1b; so when that tab is inserted into the corresponding slot 6a 6b the tab notch 1c rests within the bottom of the slot 6a 6b, thus holding the two vertical panels together. Each slot or slots 6a 6b are located on the bend 15 between the slot panel 5b and tongue 7.

A Polygonal Unibody Pole Sign 17 is installed by (a single user) bending the panels 2b 3b 4b 5b around an appropriate pole 18 with the tongue 7 inside of the Polygonal Unibody Pole Sign 17. Then bending all flaps 2a 3a 4a 5a 2c 3c 4c 5c outward, and placing Polygonal Unibody Pole Sign 17 on ground. Then feed tabs 1a 2a into slots 6a 6b reaching inside Pole Sign 17 from top (and bottom if necessary) to pull tabs 1a 2a through to rest on last tab notch 1c, until tab panel 2b and slot panel 5b are end to end on the outside of the Polygonal Unibody Pole Sign 17, and the tabs 1a 2a and tongue 7 are on the inside of the Polygonal Unibody Pole Sign 17. Then lift Polygonal Unibody Pole Sign 17 to intended height making sure panel(s) 2b 3b 4b 5b (if used for advertising) are facing the desired audience location before placing flap(s) 2a 3a 4a 5a 2c 3c 4c 5c onto pole 18. Bend slot panel 5b, bottom flap 5c under affixing onto pole 18. Then bend panel tab 2b, bottom flap 2c under affixing onto pole 18. Bend and affix the rest of the panel(s) 3b 4b, bottom flap(s) 3c 4c clockwise onto the pole 18. Beginning with the slot panel 5b, bend and affix all panel(s) 2b 3b 4b top flaps 2a 3a 4a clockwise to the pole 18.

### FIGURE NUMBERING

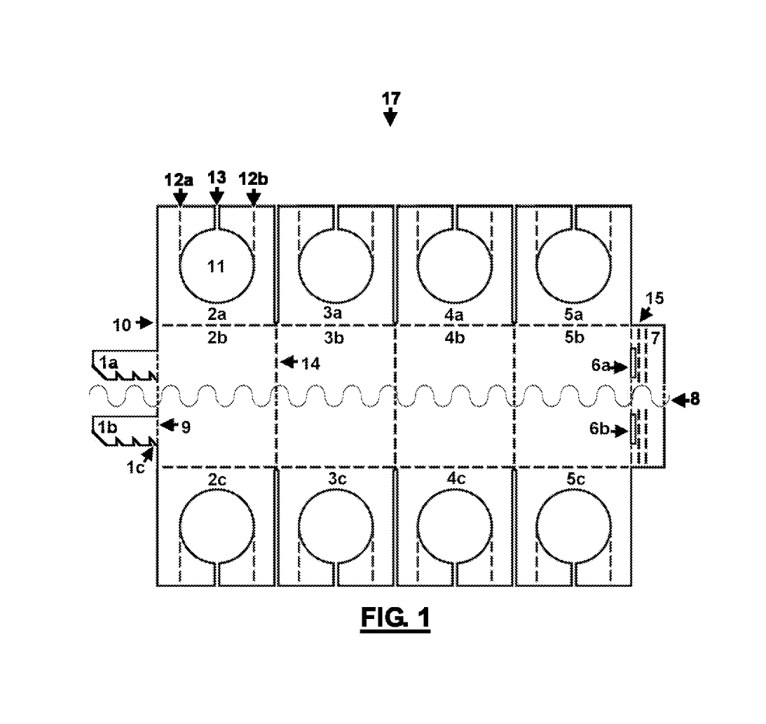

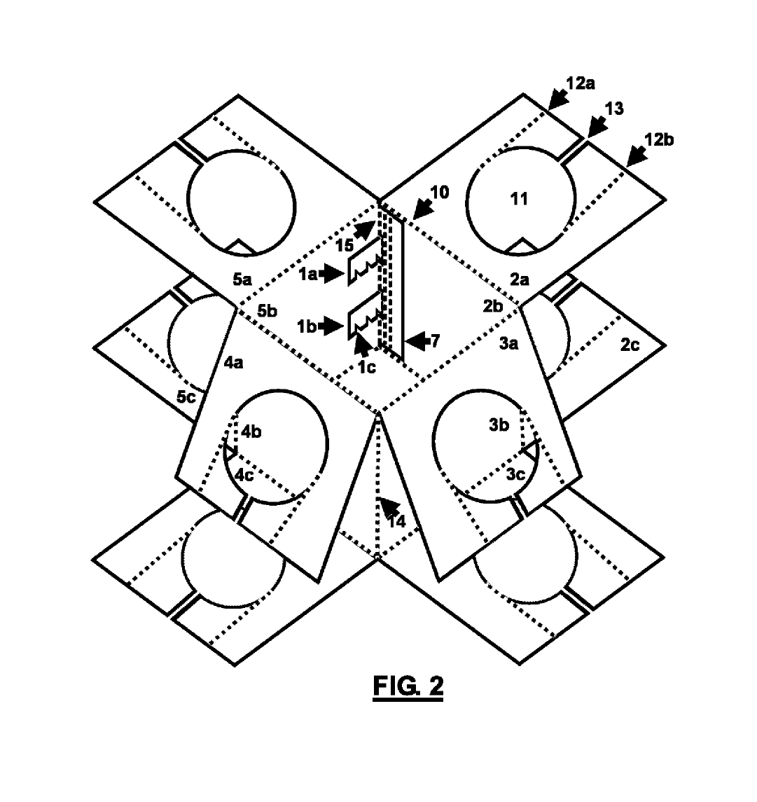

### Label Each Figure as FIG. 1, FIG. 2, Etc

1) 1a=top tab
1b=bottom tab
1c=tab notch
2) 2a=tab panel, top flap
2b=tab panel
2c=tab panel, bottom flap
3) 3a=central panel, top flap
3b=central panel
3c=central panel, bottom flap
4) 4a=additional panel, top flap
4b=additional panel
4c=additional panel, bottom flap
5) 5a=slot panel, top flap
5b=slot panel
5c=slot panel, bottom flap
6) 6a=top slot
6b=bottom slot
7) 7=tongue
8) 8=variable height axis
9) 9=tab bend
10) 10=flap bend
11) 11=flap hole
12) 12a=flap fold
12b=flap fold
13) 13=flap cut
14) 14=panel bend
15) 15=tongue bend
16) 16=perforation
17) 17=Polygonal Unibody Pole Sign
18) 18=pole
19) 19a=alternative flap design
19b=alternative flap design
19c=alternative flap design
19d=alternative flap design
PARTS: Tab (+tab notch), Tongue (+slot), Panel, Flap (+aperture, cut, bend), perforation, variable height axis

### A BRIEF DESCRIPTION OF THE DRAWINGS

FIG. 1—Is a plan view of an embodiment of the present invention.

FIG. 2—Is a perspective view of FIG. 1, which is joined and partially folded.

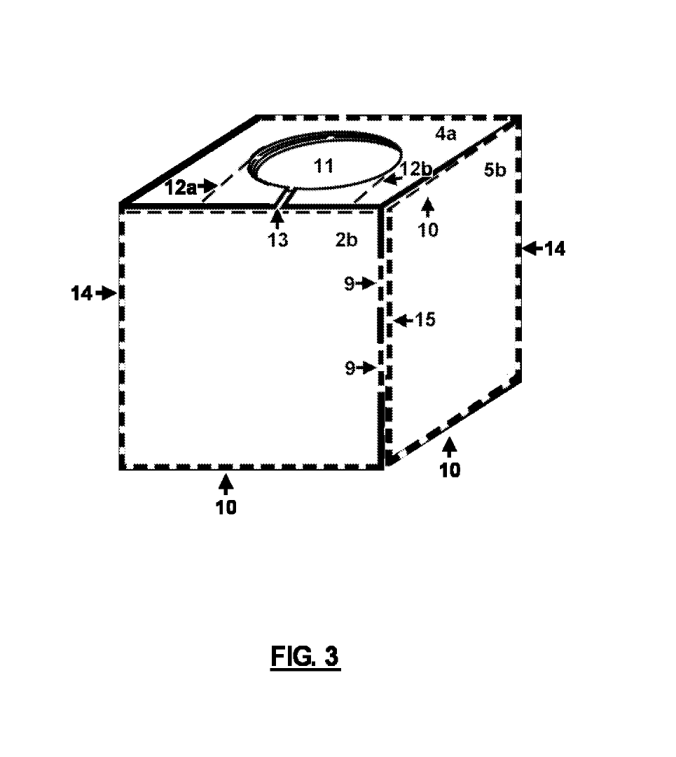

FIG. 3—Is a perspective view of FIG. 1, which is joined and completely folded.

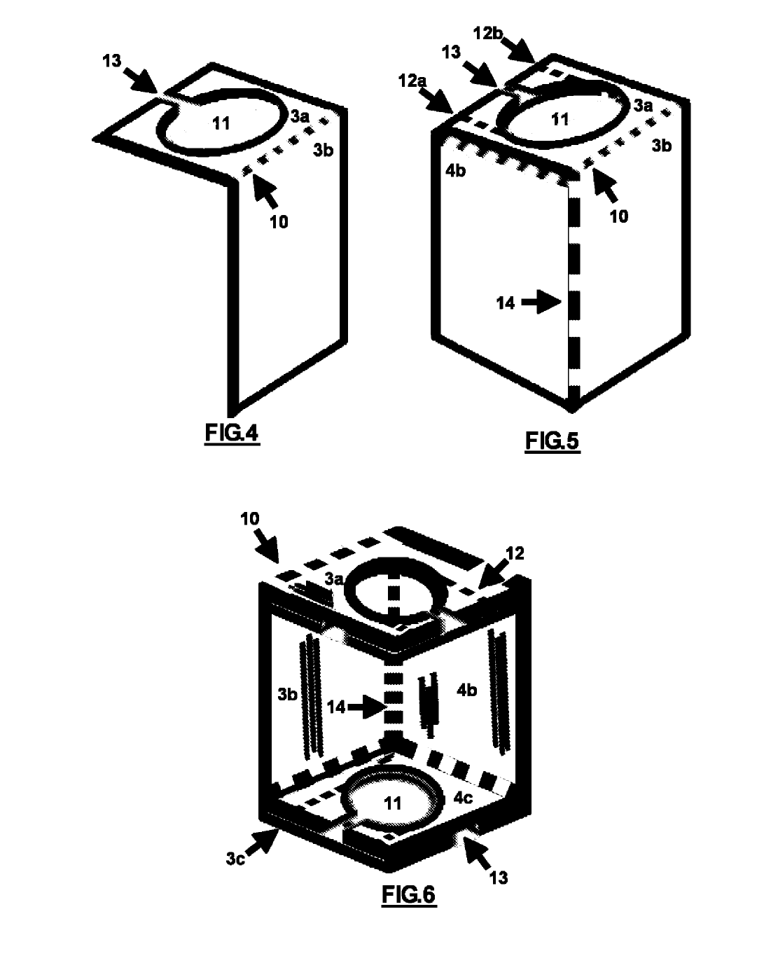

FIG. 4—Is a perspective view of an alternate embodiment of the present invention consisting of one flap without folds, and one panel.

FIG. 5—Is a perspective view from the front of a second alternate embodiment of the present invention consisting of two top flaps, two bottom flaps, and two panels that are completely folded.

FIG. 6—Is a perspective view from the rear of FIG. 5.

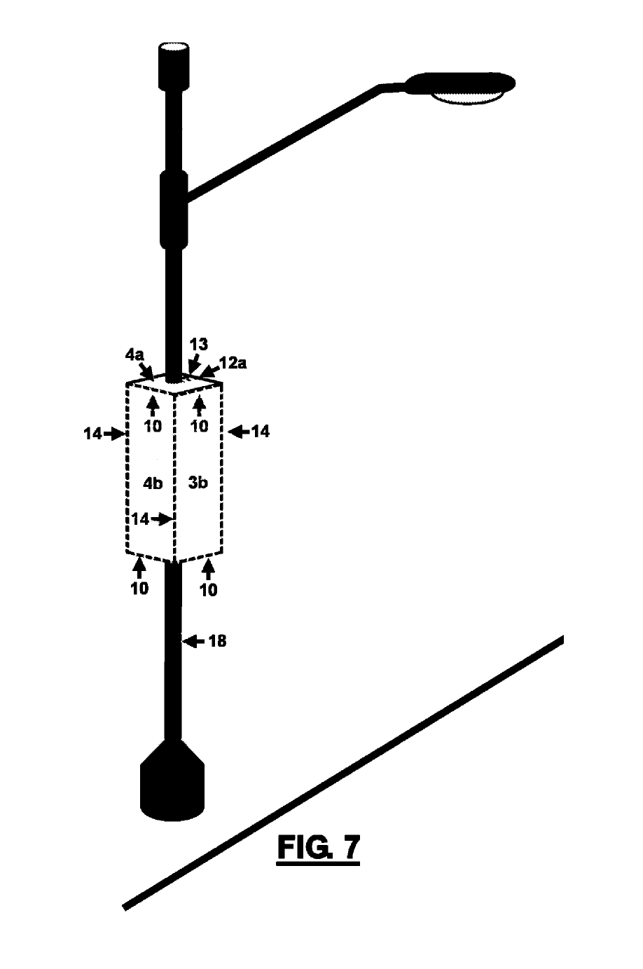

FIG. 7—Is a perspective view of FIG. 1, with longer vertical panels, which is installed.

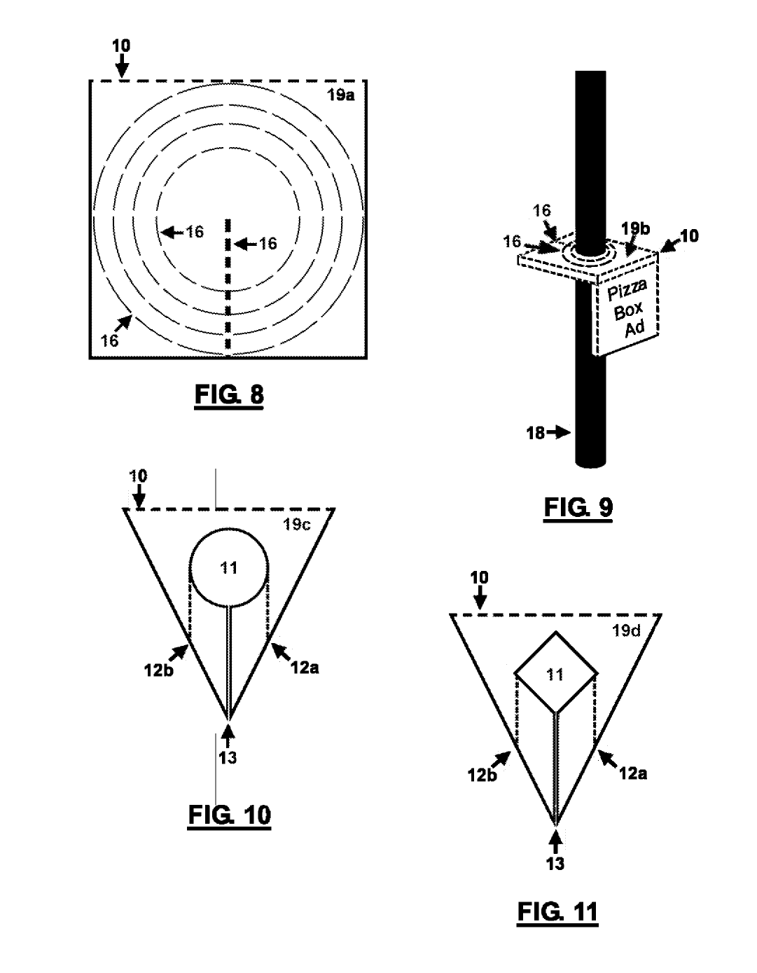

FIG. 8—Is a plan view of the top of FIG. 4 displaying an alternate flap design to provide variable apertures for multiple diameter poles.

FIG. 9—Is a perspective view of FIG. 8 displaying potential use.

FIG. 10—Is a plan view of the flap of a third alternate embodiment, consisting of three panels, three top flaps and three bottom flaps, to create a triangular shaped figure.

What is claimed is:

1. The Polygonal Unibody Pole Sign is an article comprised of a single piece of simi-rigid material, with one or more side panels and one or more flaps. Each flap having a cut and aperture sufficiently large to be folded or bent to encompass a pole, column or beam, with sufficient contact between the interior of the flap aperture and pole, to keep the final assembled article elevated at a fixed position, to present one or multiple panels for the purpose of advertisement, display or decoration.

2. The Polygonal Unibody Pole Sign in claim 1 states that the article is: With one or more side panels and one or more flaps:
a. As each flap requires a single cut to properly fit around a pole, column or beam, each panel may add a bottom flap for additional support, giving a total of two flaps per panel; one on the top and one on the bottom of each panel. The more flaps a figure has, the more points of contact it has with the pole, thus the sturdier the figure becomes.
b. As the number of panels increase, the area of neighboring flaps must be decreased to allow those flaps to remain flush with their neighboring panel face.
c. As three or more panels are able to encompass a pole, column or beam, the flaps should reflect the shape the panels make when the pole is encompassed to retain a flush dynamic, but are not required to have the same number of flaps as there are panels (examples):
i. Three panels have triangle shaped flaps, but do not require 3 flaps.
ii. Four panels have square or rectangular shaped flaps, but do not require four flaps.
iii. Five panels have pentagon shaped flaps, but do not require five flaps.
iv. Six panels have hexagon shaped flaps, but do not require six flaps (and so on).

3. The Polygonal Unibody Pole Sign in claim 2 states: Three or more panels are able to encompass a pole, column or beam:
a. As each outside panel touches the article's opposite outside panel, the addition of slots and tabs help, but is not required, to hold the article's shape in place around the pole.
b. As the article elongates horizontally and/or vertically, additional slots and tabs can be added along the flaps and panels to add support, and are unique to the purpose and environmental conditions of that article.

4. The Polygonal Unibody Pole Sign in claim 1 is intended to be used for:
a. Advertising—each panel can be used to convey information or instructions in writing, print, and/or attached form.
b. Weight bearing—fully formed articles have the ability to hold small amounts of weight.
i. Display—holes may be designed into the figure to view or hold objects inside
ii. Support—objects may be placed on top of or hung from the article
c. Art—designs may be written, printed, and/or attached to the article for visual aesthetics.
d. Multiuse—creating the Polygonal Unibody Pole Sign design into existing products:
i. Polygonal Unibody Pole Sign—two different messages
1. As the Polygonal Unibody Pole Sign can be turned inside out, information and/or instructions can be written, printed, and/or attached on both the inside and outside surfaces
ii. Polygonal Unibody Pole Sign—two different uses
1. Example: Pizza Box—after being used to hold a pizza, a hole with cut may be punched out of the middle of the pizza box, so it can be bent onto a light pole outside of the residence to show a printed or written message in support of a sports team, local cause, movie, and/or event.
